(19) United States
(12) Patent Application Publication
(10) Pub. No.: US 2009/0048902 A1
(43) Pub. Date: Feb. 19, 2009

(54) Method And System For Dynamically Serving Targeted Consumer Clicks Through An Application Programming Interface Over A Network

(75) Inventors: Scott Lynn, Kansas City, MO (US); David Phillips, Leawood, KS (US); Bryce Anson, Leawood, KS (US)

Correspondence Address: LATHROP & GAGE LC, 2345 GRAND AVENUE, SUITE 2800, KANSAS CITY, MO, 64108, US

(73) Assignee: ADKNOWLEDGE, INC., Kansas City, MO (US)

(21) Appl. No.: 12/041,518

(22) Filed: Mar. 3, 2008

Related U.S. Application Data
(60) Provisional application No. 60/904,315, filed on Mar. 1, 2007.

(51) Int. Cl. G06F 17/30

(52) U.S. Cl. 705/10

(57) ABSTRACT

Methods and systems are disclosed for analyzing consumer clicks (clicks) received from search engines from a listing, that includes at least one activatable link, associated with a target web site. The analysis is such that the analyzed clicks serve as the basis for targeting future clicks so that advertisers pay click aggregating bidders (click aggregators) for these fixture clicks at rates corresponding to the quality of the click. The click aggregators adjust the amounts they pay to the search engines that carry the listings corresponding to the requisite advertiser, based on amount they receive from the advertiser.

### CROSS-REFERENCES TO RELATED APPLICATIONS

This application is based on and claims priority from U.S. Provisional Patent Application Ser. No. 60/904,315, filed Mar. 1, 2007, entitled: Method and System For Dynamically Serving Targeted Consumer Clicks Through an Application Programming Interface Over a Network, the disclosure of which is incorporated by reference herein.

### TECHNICAL FIELD

The present disclosed subject matter is directed to methods and systems for analyzing consumer clicks (clicks) received from search engines, and managing future traffic by click aggregation.

### BACKGROUND

Businesses are allocating increasing financial resources to attract consumers over the Internet. One popular way to advertise over the Internet is for search engines, such as Google® (www.google.com), Yahoo!® (www.yahoo.com) and others, to display listings associated with words, referred to as keywords, in a priority order. Each keyword is typically associated with a promotional listing to at least one web site or web page (hereinafter, referred to collectively as a “web site”) of a web site promoter (owner, controller, or other party associated with a web site), and typically, multiple listings for individual web sites of corresponding web site promoters. Each of the web site promoters has agreed to pay the search engine a monetary amount for directing consumers to their web site. This occurs through the following process: 1) a consumer enters a relevant keyword in a search engine's search box; 2) the consumer receives listings generated by the search engine from the keyword, which listings are typically provided in a graphical user interface (GUI) or other similar on-screen display; 3) the consumer then activates or “clicks” their pointing device, or mouse, on the desired listing; and 4) the consumer?s web browser is directed to the target web site, associated with a specific web site promoter.

The “click” may be recorded by the search engine, and the “click through” to the web site, indicating the consumer's browser has reached the targeted web site, may be recorded by the web site promoter. By using and comparing such recorded data, the search engine and the web site promoter can track how many consumers were successfully sent to the relevant web site by the search engine.

The web site promoter willing to pay the most amount of money for a user's pointing device or mouse click on a listing associated with the web site promoter, such that the consumer's browser is directed to a targeted (target) web site associated with the web site promoter, is usually provided with the first or top priority listing for the particular key word, of the listings generated in an on-screen display. This advertising technique is commonly known as pay per click (PPC) advertising.

Search engines such as Yahoo® and Google® are a species of “consumer click collectors” or more simply, “click aggregators.” Google® and Yahoo® in particular consistently attract a large, dynamic community of consumers who view advertisements displayed on the web pages of the search engine or its partners, and some of these consumers click on the advertisements, resulting in payments to the search engines. There are, however, many other click aggregators besides Yahoo® and Google®.

Many of these click aggregators reach consumers through different distribution methods. Some are search engines which are smaller than Yahoo® or Google® (as measured by sophistication of search and ranking formulae, revenue, advertiser base and average daily number of consumer-users). The consumers are also reached through, banners, pop-up or pop-under advertisements, text-based listings on websites or via email advertisements. For example, click aggregator Quigo® provides a targeted advertising solution, Adsonar™, by placing advertisements in online directories and specific high-traffic web pages; it does not rely upon search engines.

Due to the diversity of Internet click fraud, such fraud consequently tends to be increasingly associated with smaller click aggregators. This tends to limit the amounts advertisers are willing to spend advertising with or through them. In addition, click aggregators which are niche or small, may not in absolute numbers attract a large community of consumers (that is, bona fide clickers), even if they attract a specific community which may be of great interest to one or more categories of advertisers. Collectively, however, such click aggregators provide promotional access to a large class of consumers segmented or categorized in a valuable manner.

### SUMMARY

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen display, for example, an activatable link, that causes an action of the various software and or hardware supporting the computer screen display. For example, a “click” also includes the direction of redirection of a browsing application (or browser) associated with the computer of the user or entity upon the activation of the mouse or computer pointing device associated with the aforementioned computer.

A banner is a graphic that appears on the monitor of a user, typically over a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as they are placed into the creative, at the time the creative is activated, which may be upon the opening of an electronic communication, or e-mail with the creative. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouser or pointing device, the corresponding underlying link is activated causing the user's or intended recipients browsing application or browser to be directed to the target web site corresponding to the activated link.

Pay Per Click (PPC), also known as price per click and cost per click, as used herein, is the amount of money that an advertiser, web site promoter, or other party who owns, controls or is associated with a web site (for example, a targeted or target web site), will pay to a system administrator for providing their advertisement, listing, link or the like to a user, onto which the user clicks their mouse or pointing device on the advertisement, listing, link or the like, such that the user's browser is directed to the targeted web site associated with the advertiser, web site promoter, or other party who owns, controls or is associated with the targeted web site.

A “client” is an application that runs on a computer, workstation or the like and relies on a server to perform some operations, such as sending and receiving e-mail.

“n” and “nth” in the description below and the drawing figures represents the last member of a series or sequence of servers, databases, caches, components, listings, links, data files, etc.

“Click through” or “click throughs” are industry standard terms for a user clicking on an activatable link or portion overlying or connected to the activatable link, in an electronic object, such as an e-mail, banner, listing or other portion on a web site, for example, a web site of a search engine, or the like, and ultimately having their browser directed to the targeted data object, typically a target web page or web site, associated with the link.

An “engine” is a program or algorithm that performs a core or essential function for other programs. An engine can be a central or focal program in an operating system, subsystem, or application program that coordinates the overall operation of other programs. It is also used to describe a special-purpose program containing an algorithm that can sometimes be changed.

“HTTP (Hypertext Transfer Protocol) cookies”, “cookies,” or “cookie files” are parcels of text, for example, file(s), sent by a server from a specific domain to a web browsing application or web browser, and then sent back unchanged by the browsing application or browser each time it accesses that server or when a connection between the server and the browsing application or browser is open. The HTTP cookies, cookies or cookie files are only sent back to the domain that originally sent them.

The present disclosed subject matter permits web site promoters, for example, advertisers, and click aggregators to collectively leverage value from each other, such that advertisers have access to a community both broad in absolute numbers and niche or segmented in a variety of narrow categories. Advertisers tend to be willing to pay more for access to such a community, particularly where concerns about click fraud are muted. Click aggregators which individually could not command higher prices for advertisements while remaining independent, may utilize the present disclosed subject matter to realize improved revenue.

The current disclosed subject matter is directed to advertising methods over an electronic network, such as the Internet, designed to accurately segment consumers for advertisers from large but unsegmented pools or sources of consumers, in a manner generating profit for the users of the disclosed system and methods. In particular, the disclosed subject matter is directed to methods for driving consumer clicks to advertisers. This is accomplished through distribution of advertisements via a variety of methods, including electronic communications and receiving and filtering consumer clicks, as detailed herein, and prioritizing and targeting delivery of advertisements in a manner designed to generate profit. The particular manner of distribution is determined in real-time by a multi-element formula, including the price charged by click aggregators to the advertising service provider (“ASP”) for the clicks delivered to the ASP's customer (generally, an advertiser who created, either alone or in cooperation with the same or a different ASP, the advertising communication), and other specific behaviors and actions, and/or imposed rules from the various members of the network community.

The present disclosed subject matter is directed to methods and systems for analyzing consumer clicks (clicks) received from search engines from a listing, that includes at least one activatable link, associated with a target web site. The analysis is such that the analyzed clicks serve as the basis for targeting future clicks so that advertisers pay click aggregating bidders (click aggregators) for these future clicks at rates corresponding to the quality of the click. This eliminates the effect of receiving clicks that are of low value or without any chance of conversion, for example, that come from fraudulent activity at web sites, by parties attempting to increase revenues fraudulently, or through other forms of click fraud. The click aggregators adjust the amounts they pay to the search engines that carry the listings corresponding to the requisite advertiser, based on amount they receive from the advertiser. The clicks are such that the search engine directs the click to a server or the like associated with the bidder (click aggregator), allowing for the server associated with the bidder to redirect the click to a target web site associated with the advertiser, opening a connection between the server associated with the bidder (click aggregator) and the target web site, allowing for the click and events associated therewith to be analyzed, to control the future clicks directed to the advertiser, through the server associated with the bidder (click aggregator).

The present disclosed subject matter is directed to a method for traffic management over a network, for example, the Internet. The method includes placing a bid corresponding to a listing associated with a target web site, the bid defining a present bid. The browsing application of a computer device associated with at least one entity who has activated the listing associated with the target web site is directed to the target web site. Data associated with the browsing application associated with the at least one entity having accessed the target web site is received and analyzed with respect to at least one parameter associated with the target web site to determine a subsequent bid. The subsequent bid is provided to the listing associated with the target web site.

Another embodiment is directed to a system for traffic management over a network, for example, the Internet. The system includes multiple integrated components. There is a first component for providing a bid corresponding to a listing associated with a target web site, the bid defining a present bid. There is a second component for directing the browsing application of a computer device associated with at least one entity who has activated the listing associated with the target web site to the target web site. There is a third component for receiving data associated with the browsing application associated with the at least one entity having accessed the target web site. There is a fourth component for analyzing the received data with respect to at least one parameter associated with the target web site to determine a subsequent bid, and a fifth component for providing the subsequent bid to the listing associated with the target web site.

Another embodiment is directed to a computer-usable storage medium having a computer program embodied thereon for causing a suitably programmed system to manage traffic over a network, by performing the following steps when such program is executed on the system. The steps include placing a bid corresponding to a listing associated with a target web site, the bid defining a present bid; directing the browsing application of a computer device associated with at least one entity who has activated the listing associated with the target web site to the target web site; receiving data associated with the browsing application associated with the at least one entity having accessed the target web site; analyzing the received data with respect to at least one parameter associated with the target web site to determine a subsequent bid; and, providing the subsequent bid to the listing associated with the target web site.

Another embodiment is directed to a method for traffic management over a network, for example, the Internet. The method includes providing a bid corresponding to a listing associated with a target web site, and directing the browsing application of a computer device associated with at least one entity who has activated the listing associated with the target web site to the target web site. Data associated with the browsing application associated with the at least one entity having accessed the target web site is received, and the received data is analyzed with respect to at least one parameter associated with the target web site, to determine an at least one rule for the listing with the bid. The at least one rule is sent to the at least one listing.

### BRIEF DESCRIPTION OF DRAWINGS

Attention is now directed to the drawings, where like reference numerals or characters indicate corresponding or like components. In the drawings:

FIG. 1 is a diagram of an exemplary system on which an embodiment of the disclosed subject matter is performed;

FIG. 2 is a diagram of a listing created in the listing engine;

FIG. 3 is a diagram from one or more databases of the data server showing the current state of the bids in the current time interval, that are being used by the requisite search engine;

FIGS. 4A and 4B are a flow diagram of a process for generating the content for an e-mail in accordance with an embodiment of the disclosed subject matter;

FIGS. 5A and 5B are screen shots showing a third party web site with a search box and a search term being entered into the search box;

FIG. 6A is a screen shot of the listings from a search engine, that appears on the screen of a user's computer;

FIG. 6B is a diagram of the data in a one or more databases of the server supporting the screen shot of FIG. 6A;

FIG. 7A is a screen shot from the user's computer of a landing page caused by a redirect of the user's browser to a target web site;

FIG. 7B is a screen shot from the users computer of a landing page with a box being activated to move to another web page of the web site;

FIG. 7C is a screen shot from the user's computer of a web page where the user enters information;

FIG. 7D is a screen shot from the user's computer of a web page after a conversion has been made; and

FIG. 8 is a diagram of a database in the data server showing the bids being adjusted for the new time interval.

### DETAILED DESCRIPTION OF THE DRAWINGS

Throughout this document, numerous textual and graphical references are made to trademarks. These trademarks are the property of their respective owners, and are referenced only for explanation purposes herein.

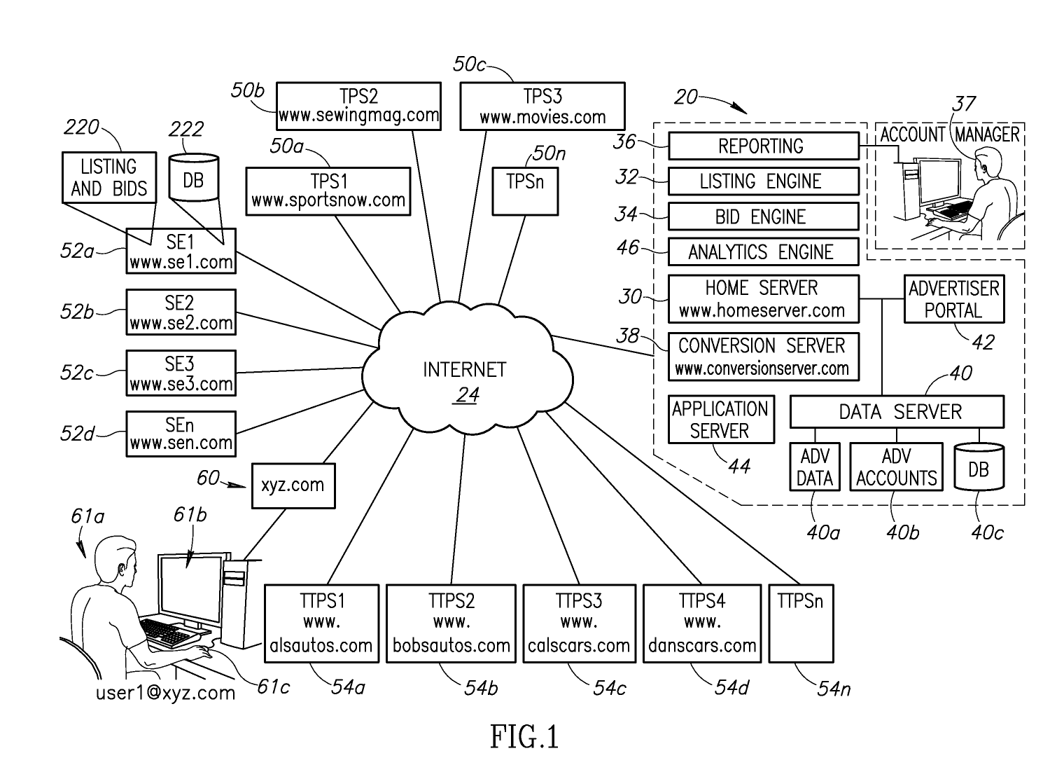

FIG. 1 shows the present disclosed subject matter in an exemplary operation. The present disclosed subject matter employs a system 20, formed of various servers and server components, that are linked to a network, such as a wide area network (WAN), that may be, for example, the Internet 24.

There are, for example, numerous servers and/or components that form the system 20, shown by the broken line box. The system 20 controls interaction between the other components described herein that are linked to the wide area network, for example, the Internet 24, both directly and indirectly.

These servers and/or components, for example, include a home server (HS) 30, a listing engine 32, a bid engine 34, a reporting server 36, accessible by a account manager 37, system administrator or personnel associated with the system 20, a conversion server 38, a data server 40 an advertiser portal 42, an application server 44 and an analytics engine 46, and all components associated therewith.

These servers, engines and/or components 30, 32, 34 36, 38, 40, 42, 44 and 46 are linked to the Internet 24, so as to be in electronic communication, direct or indirect, with each other. When shown connected by lines, this indicates a connection between the specific server, engine and/or components and the requisite component. The servers, engines, and/or components 30, 32, 34, 36, 38, 40, 42, 44 and 46 include multiple components for performing the requisite functions as detailed below, and the components may be based in hardware, software, or combinations thereof, and may also have internal storage media and/or be associated with external storage media.

The system 20 is shown in conjunction with numerous servers, components and the like, linked to the wide area network 24, either directly or indirectly. These servers, components and the like may include third party servers (TPS) 50a-50n, Search Engine Servers (SE1-SEn) 52a-52n, and Target Third Party Servers (TTPS1-TTPSn) 54a-54n. The third party servers 50a-50n, Search Engine Servers 52a-52n and Target Third Party servers (TTPS) 54a-54n may be controlled by website promoters, advertisers, publishers, content providers, and other entitles, that are typically unrelated by may be related to each other or the entity controlling the system 20.

The servers, engines and/or components 30, 32, 34, 36, 38, 40, 42, 44, 46 of the system 20 are linked (either directly or indirectly) to an endless number of other servers and the like, via the Internet 24. Other servers, exemplary for describing the operation of the system 20, include a domain server 60 for the domain (for example, the domain “xyz.com”) of the user 61a (for example, whose e-mail address is user1@xyz.com), linked to the computer 61b of the user 61a. The user 61a is representative of the multiple users of the wide area network 24 who will interact with the system 20. For example, the user 61a (for example, also an intended recipient of an e-mail from the Bid System, as detailed below) has a computer 61b (such as a multimedia personal computer with a Pentium® CPU, that employs a Windows® operating system), or other computer device, that uses an e-mail client. The computer 61b is linked to the Internet 24. The computer 61b may also be operated by an activatable pointer, such as a mouse 61c or the like. While the user 61a shown is human, the user may be an entity such as a machine or the like.

The computer 61b of the user 61a includes an e-mail client (detailed above), installed thereon, that provides the user with a unique address and the ability to utilize one or more e-mail addresses. For example, the user 61a has an e-mail address, user1@xyz.com, through which he receives his e-mail from the domain server 60, that hosts the domain xyz.com, of which the user 61a is a member. The computer 61b also includes a web browser, browsing software, application, or the like, to access web sites or web pages from various servers and the like, on the Internet 24. Some exemplary web browsers/web browsing software include, Internet Explorer®, from Microsoft, Redmond, Wash., and Netscape® Navigator®.

While various servers have been listed, this is exemplary only, as the present disclosed subject matter can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to a network, such as the Internet 24, either directly or indirectly.

The home server (HS) 30 is of an architecture that includes one or more components, modules and the like, for providing numerous additional server functions and operations, for example, browser directing and redirecting (the browsers associated with various users) to target web sites, e-mail functions, comparison and matching functions, policy and/or rules processing, various search and other operational engines, browser directing and redirecting functions, and the like. The home server (HS) 30 includes various processors, including microprocessors, for performing the server functions and operations detailed herein, and storage media, either internal or associated therewith, such as caches, databases, as well as numerous other additional storage media, both internal and external thereto. For explanation purposes, the home server (HS) 30 may have a uniform resource locator (URL) of, for example, www.homeserver.com. While a single home server (HS) 30 is shown, the home server (HS) 30 may be formed of multiple servers and/or components.

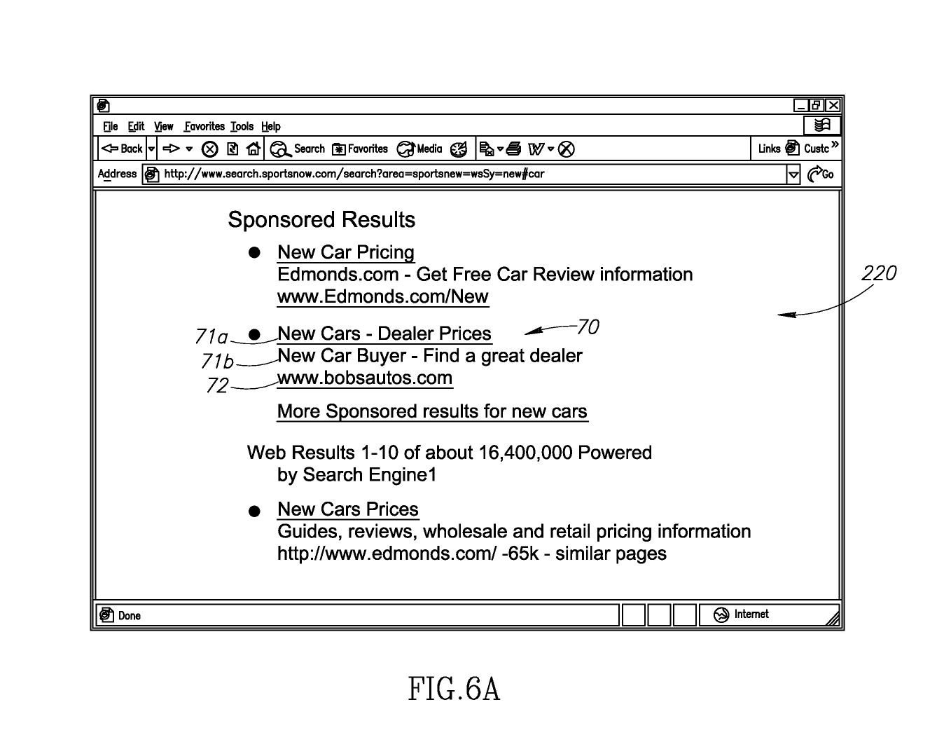

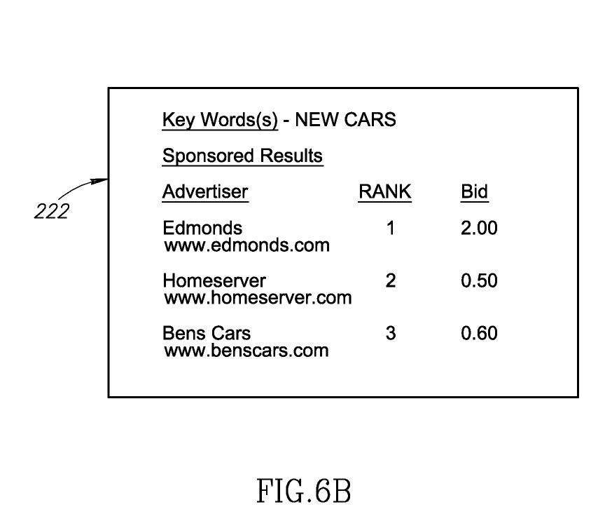

The listing engine 32 creates listings that will be the subject of bids placed into the various search engines (SE1-SEn) 52a-52n. Each server hosting the respective search engine, has a corresponding URL, for example, Search Engine 1 (SE1) has the URL of www.se1.com. The listings are in the form of data or code that appear on-screen as show, for example, in FIG. 6A, with the data for each listing in the diagram of FIG. 6B. The listing, for example, the listing shown by the broken line box 70, typically includes text segments, shown as individual broken line boxes 71a, 71b (in the broken line box 70, and a display Uniform Resource Locator (URL), in the broken line box 72 of box 70.

The listing engine 32 also compiles data or code including, a title for the listing 71a, description for the listing 71b, a click through or destination Uniform Resource Locator (URL) 73, a display URL (the actual URL that will be displayed with the listing by the search engine) 72, one or more keywords or classifications (as code, data or the like) 74, an account identification (ID) 75 for the listing engine 32, including a user name and a password, and a bid and/or rules or policies 76, as received from the bid engine 34. As shown in dotted line boxes, the click through URL 73, the keywords or classifications 74, the listing engine account ID 75 and bid 76 are not shown with the listing, as it is displayed on screen (FIG. 6).

The click through URL includes a query string, that includes at least, an identification for the traffic provider, e.g. a search engine ID, a listing ID (that identifies the listing in the listing engine 32), and a keyword ID (that identifies the one or more keywords or classifications attached to the listing). The search engine IDs, listing IDs and a keyword IDs are all in storage associated with the system 20, and for example, in databases associated with the home server 30, listing engine 32, bid engine 34 and/or conversion server 38.

For example, a click through URL for the target web site for Bob's Autos, www.bobsautos.com, hosted by the server (TTPS) 54b (controlled by an advertiser, web site promoter or other controlling entity), may be: http://bobsautos.homeserver.com/sc/3489765761235987453767645439704456

where,
“bobsautos” represents direction to the target web site for Bob's Autos (hosted by server TTPS 54b);
“homeserver” represents the home server 30 of the system 20, to which the browser is initially redirected to in the system 20, the home server 30 than making additional redirects of the user's browser (browsing application); and,
“/sc/348 . . . 456” is the query string that includes encrypted code for the traffic provider (e.g., search engine) ID, the listing ID, and the Keyword ID.

The data or code for the aforementioned listing may be in extensible markup language (XML) or any other suitable language or interface required by the search engine, on which the listing (and corresponding bid) will be placed. All of the aforementioned data or code to create the listing on the requisite web page of the requisite search engine (for example, SE1-SEn, 52a-52n) is stored in one or more storage components associated with the listing engine 32. The data or code for the listing is sent by the listing engine to the requisite search engine, when the listing is to be placed in the search engine with a bid and/or rules and/or policies associated therewith. This typically occurs when the first bid (and/or rules and/or policies) is placed in the search engine.

The bid engine 34 takes the data or code for the listing, as either pushed or pulled from the listing engine 32, and assigns a bid, for example, in the form of a monetary amount, to it. When a modified or subsequent bid or other action (for example, a rule or policy for the listing) is to be made for a listing existing in the requisite search engine, the bid (and/or rule(s) and/or policy(ies)) is then sent to the requisite search engine SE1-SEn 52a-52n over the Internet 24. The bid engine 34 includes all programs necessary for interacting with the various search engines (for example, SE1-SEn 52a-52n) on which bids (and/or rule(s) and/or policy(ies)) will be placed for advertisers associated with the system 20.

The actual bid (and/or rule(s) and/or policy(ies)) is formulated by the analytics engine 46, for which the bid engine 34 is in electronic communication therewith. Prior to sending the bid to the requisite search engine (for example, SE1-SEn 52a-52n), the bid engine 34 may execute preprogrammed rules and/or policies, as well as add or change rules or policies to existing listings, in the requisite search engine (for example, SE1-SEn 52a-52n).

The reporting server 36 coordinates numerous manual parameters. Account managers 37, for example, interface with this reporting server 36 to manually adjust the parameters. The reporting server 36 may also receive manual adjustments (from the account managers 37) such as profit margins for advertisers for the various search engines, and transfer this data to the appropriate server or component.

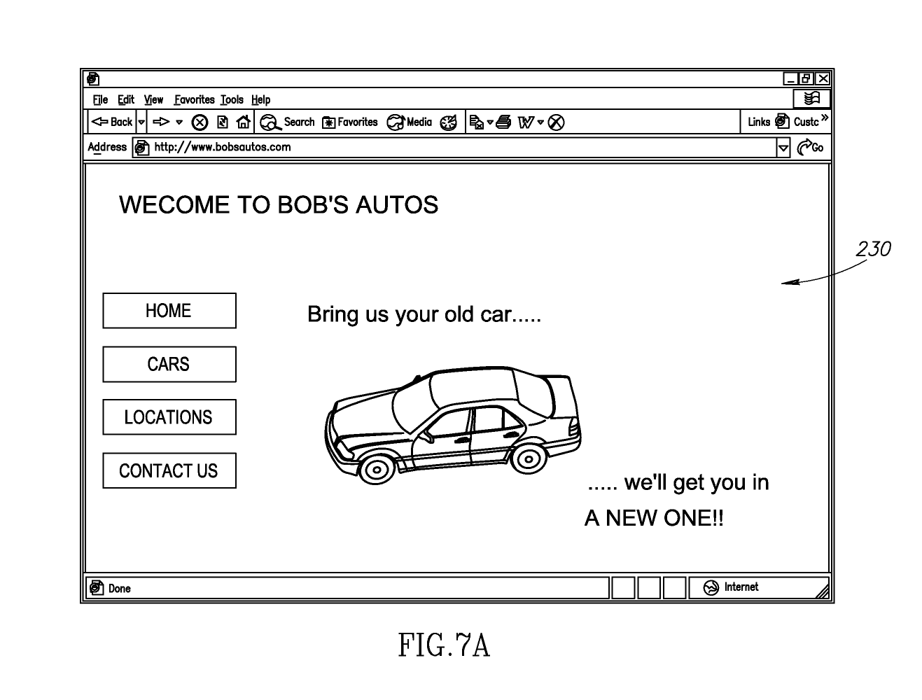

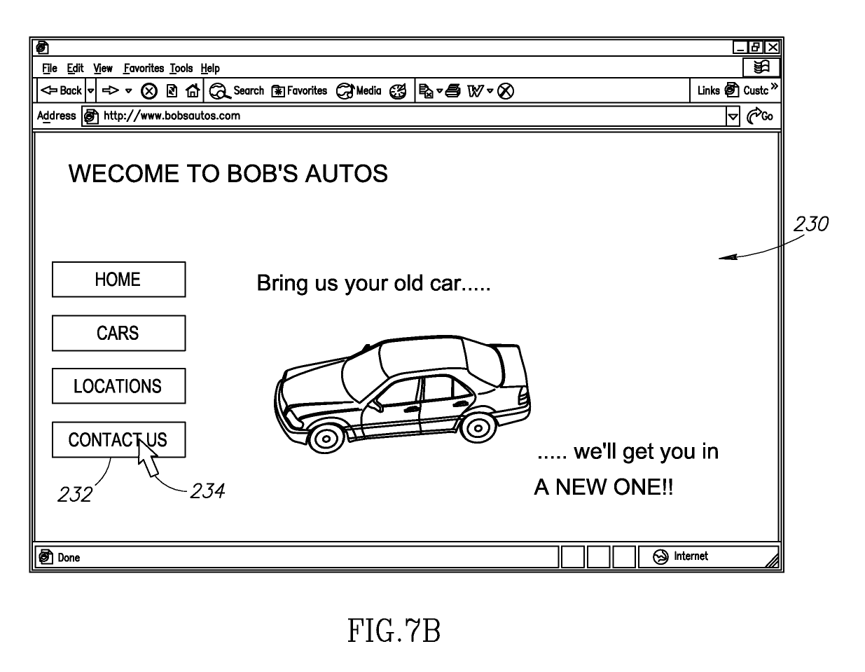

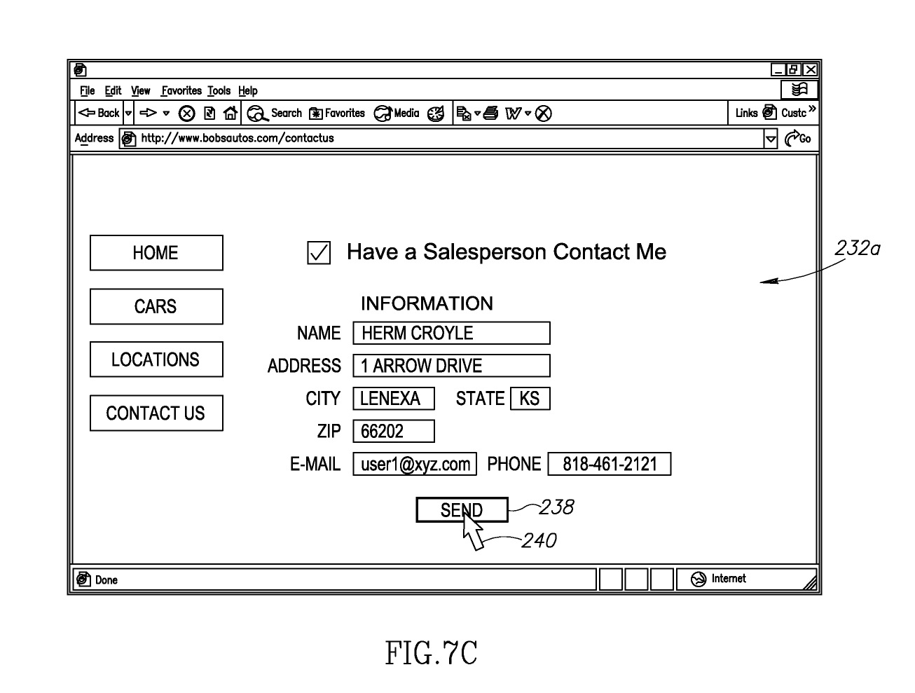

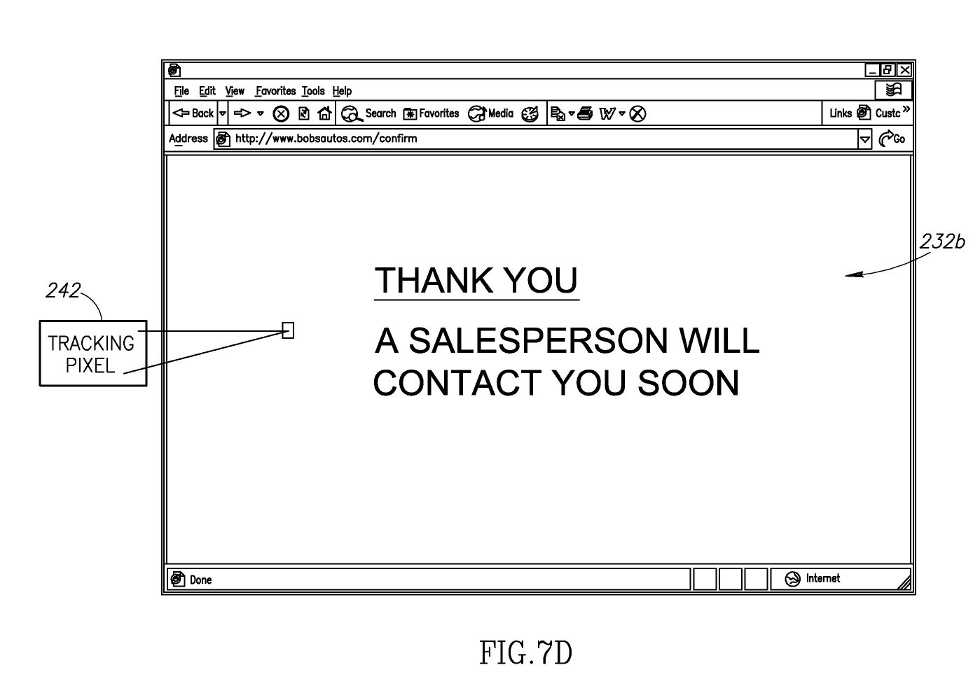

The conversion server 38 (for example, having the URL www.conversionserver.com) includes the image (“img”) from the script detailed below, for the tracking pixel, as well as cookies to be dropped onto the computer 61b of the user 61a, when the browsing application associated therewith, is redirected to the target web site (hosted, for example, by the target third party web site servers 54a-54n). The tracking pixel is, for example, a small piece of HTML code that is placed into an action web page (232b of FIG. 7D). It is, for example, a single pixel (1×1) GIF image that when activated sends data to the conversion server 38, that action has been taken. For example, a tracking pixel on the requisite web page, as placed by the web site promoter or other administrator of the web site for the web page, may be expressed as follows:

<script language=“JavaScript”
src=“http://conversionserver.com/script/35301.js”></script>
<noscript><img
src=“http://conversionserver.com/db.php?id=35301&page=unknown”>
</noscript>

where,
“img” is the image for the tracking pixel, and
src=“http://conversionserver.com/db.php? . . . unknown” is the location in the conversion server 38 where the pixel is stored, such that it can be downloaded by the requisite web page or web site.

The conversion server 38 is linked to the home server 30, in that a redirection to the home server 30 of the user's browsing application, includes being redirected to the conversion server 38 for the cookie(s) drop (to the computer of the user of the corresponding browser), prior to the redirect to the target web site (for example, represented by the target third party web site servers 54a-54n). The conversion server 38 includes software for detecting conversion events, and determining conversions, based on these conversion events (either alone or coupled with other events, occurrences or the like). The software is, for example, designed for reading the received tracking pixels and for searching for cookies, reading, retrieving and/or receiving cookies, recording and storing data associated therewith. There is also comparison software for comparing read cookies to the code associated with a received tracking pixel. For example, the comparison software allows for a verification of the cookie(s) when compared to the tracking pixel to make sure that both are associated with the system 20, from, for example, which a conversion may be verified, and, for example, to maintain accurate information about each advertiser associated with the system 20 (e.g., those of the target third party servers TTPS 54a-54n).

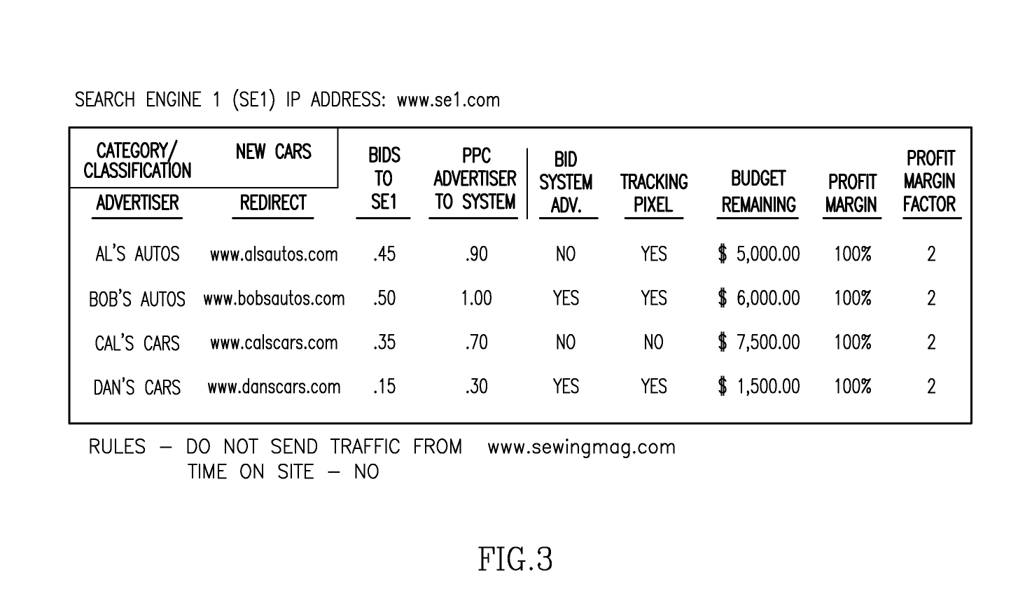

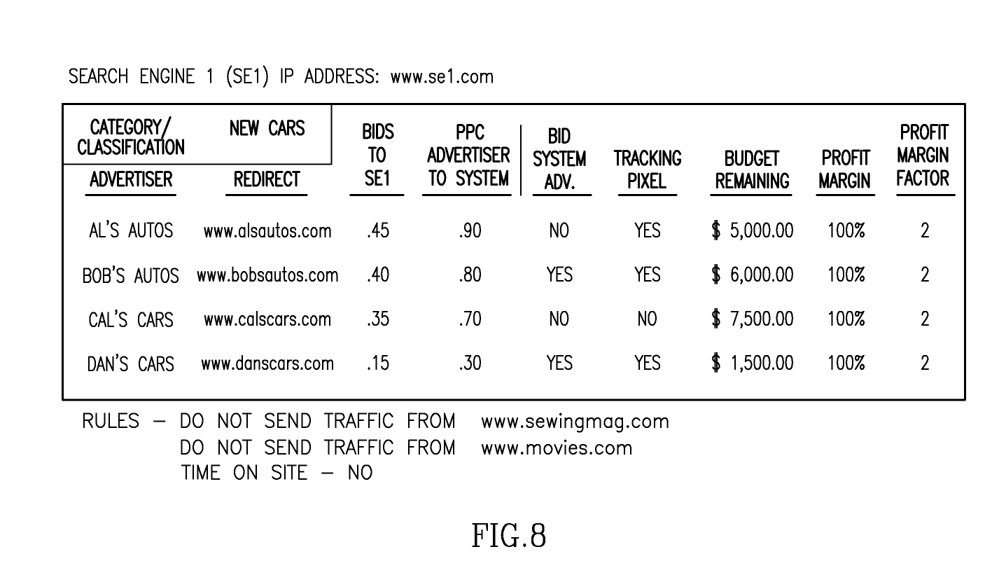

The data server 40 stores advertiser data as well as data concerning the conversions from the web sites of the associated advertisers. For example, at a first time, represented by T₁ (for example, the beginning of a time interval), the data server 40 may hold the information for advertisers, in storage media 40a-40c. For example, advertiser data, such as pay per click amounts may be stored in storage 40a, while advertiser accounts, budgets and the like may be stored in storage 40b. Other data on the advertisers may be stored in the database 40c. For example, for Search Engine 1 (SE1), data from these and other databases is arranged in a diagram of FIG. 3 (and also FIG. 8 for a subsequent time interval), along with rules and policies for that particular search engine. For example, at time T₁, the system 20 does not want any traffic or clicks from Search Engine 1, when the source of the click is server 50b, the third party server for Sewing Magazine, with the URL www.sewingmag.com.

The advertiser portal 42 is shown linked to the home server 30 and the data server 40. The advertiser portal 42 may be a location where one or more advertisers compile their data that is used in setting bids for the bid engine 34. The data may include parameters used for analytics, as discussed below, such as a value for e-mail conversions (ECPA, listed below) (from a system other than the “Bid System”, detailed below) or a substitute value therefore. For example, advertisers communicate their pay per click (PPC) amounts to the advertiser portal 42.

An exemplary advertiser portal 42 may be, for example, the system described in commonly owned and assigned U.S. patent application Ser. No. 11/256,871, entitled: System For Prioritizing Advertiser Communications Over A Network (Published as U.S. Patent Application Publication No. US2006/0248110 A1, and referred to hereinafter as the “Bid System”), the disclosure of which is incorporated by reference herein. If the aforementioned Bid System is used as the advertiser portal 42, the home server 30 includes the electronic mail and other home server functions described therein.

An application server 44 is optional and when employed is linked to the Internet 24 as well as the home server 30. The application server 44 may be one or more servers, engines components or any combination thereof. An exemplary application that may be placed on the application server is described in commonly owned and assigned U.S. patent application Ser. No. 11/844,983, entitled: Methods And Systems For Monitoring Time On A Web Site And Detecting Click Validity (Published as U.S. Patent Application Publication No. US2008/0052629 A1, and referred to hereinafter as the “Time On Site (TOS) Application”), the disclosure of which is incorporated by reference herein. Like the Bid System, portions of the Time On Site (TOS) Application may be incorporated into the home server 30.

An analytics engine 46 includes all necessary hardware and/or software for utilizing conversion information, as well as other information, such as a user's time on a web site, to continuously adjust the bid amount for each advertiser for each particular search engine which the system 20 is associated with. The analytics engine 46 creates groups based on past clicks, also known as traffic, and segments the clicks or traffic. A quality score is obtained from the past clicks and is calculated against known parameters. Based on this calculation, the bid for the requisite search engine is determined, it is stored in the data server 40, and is sent to the bid engine 34 (that in turn, sends the bid for the listing corresponding to the requisite advertiser, to the requisite search engine).

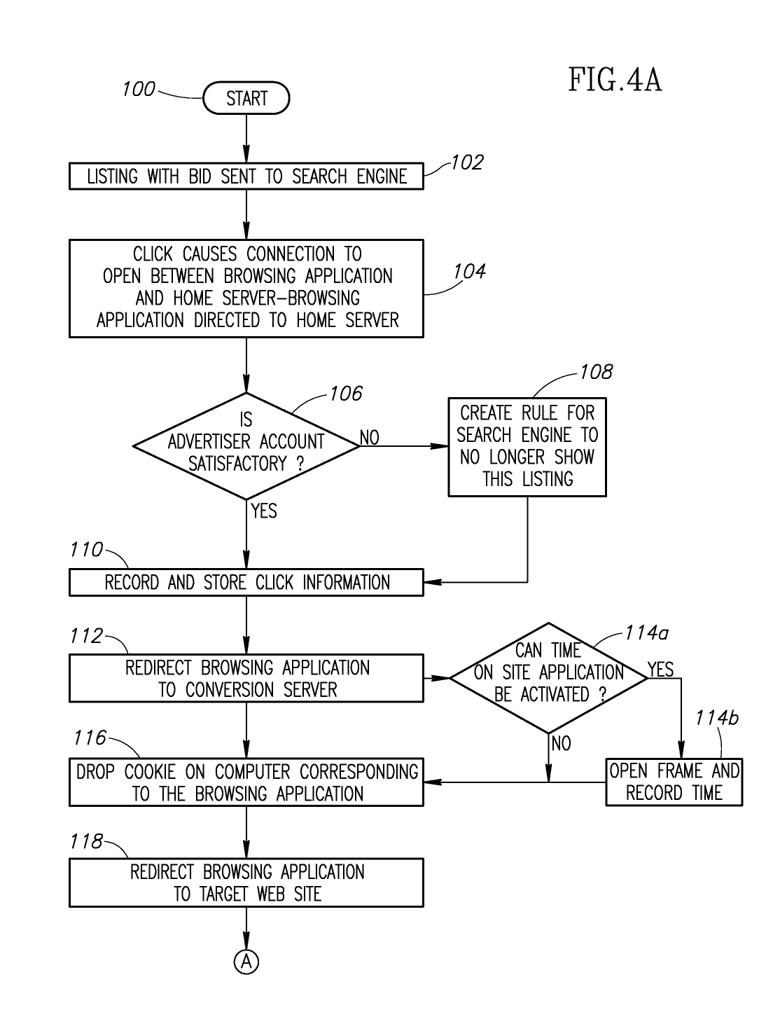

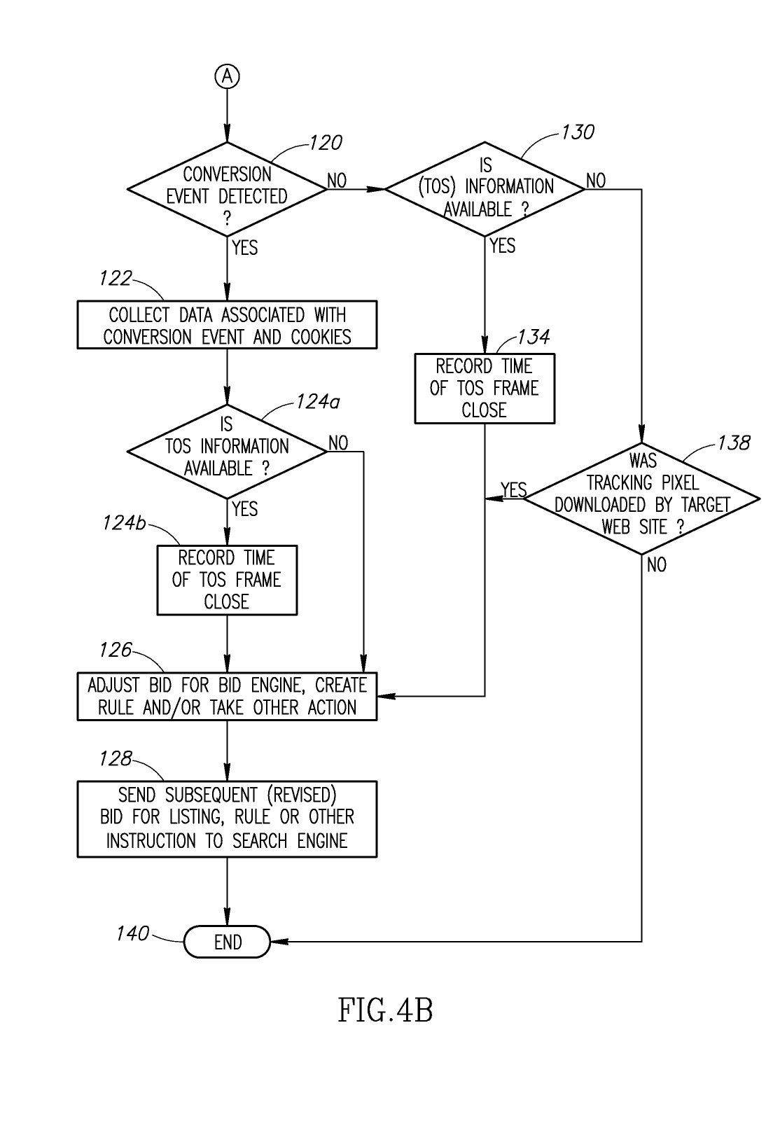

Turning also to FIGS. 4A and 4B, an exemplary implementation of a process in accordance with an embodiment of the disclosed subject matter will now be described. FIGS. 4A and 4B are a flow diagram of the process (method), for maintaining or changing a bid associated with a listing in a search engine and/or sending a rule to the search engine for the requisite listing in accordance with analysis of the clicks associated with the listing. The flow diagram of FIGS. 4A and 4B is accompanied by FIGS. 1-3 and 5-8, to further explain the processes described in the flow diagram.

The process starts at block 100. The system 20, through the listing engine 32, sends the listing with the bid for a keyword (classification or category) to the requisite server corresponding to the search engine, for example, Search Engine 1 (SE) 52a with a URL of www.se1.com, at block 102. Rules and/or policies can also be sent at this time. The search engine, for example Search Engine 1 (SE1) 52a, organizes the listings for each keyword or other identifier, typically in accordance with bid amounts, and these listings are, for example, for placement in the “Sponsored Results” section of the web page for the search engine (for example, the web page 220 for Search Engine 1 (SE1) shown in FIG. 6).

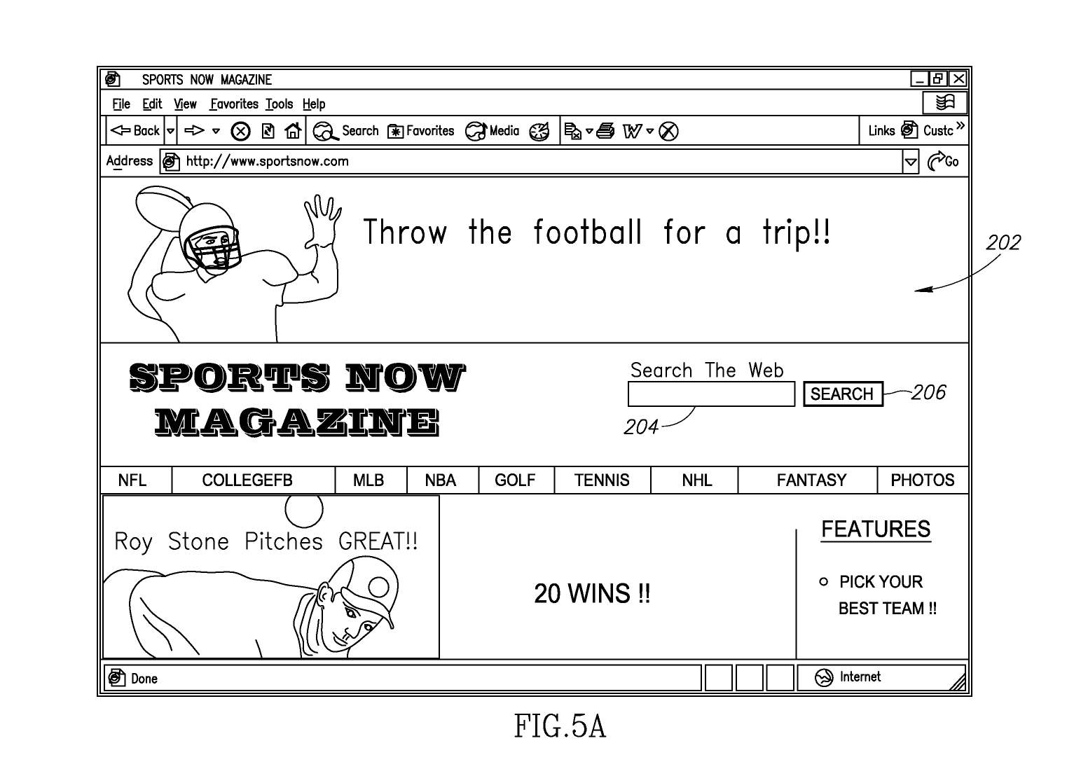

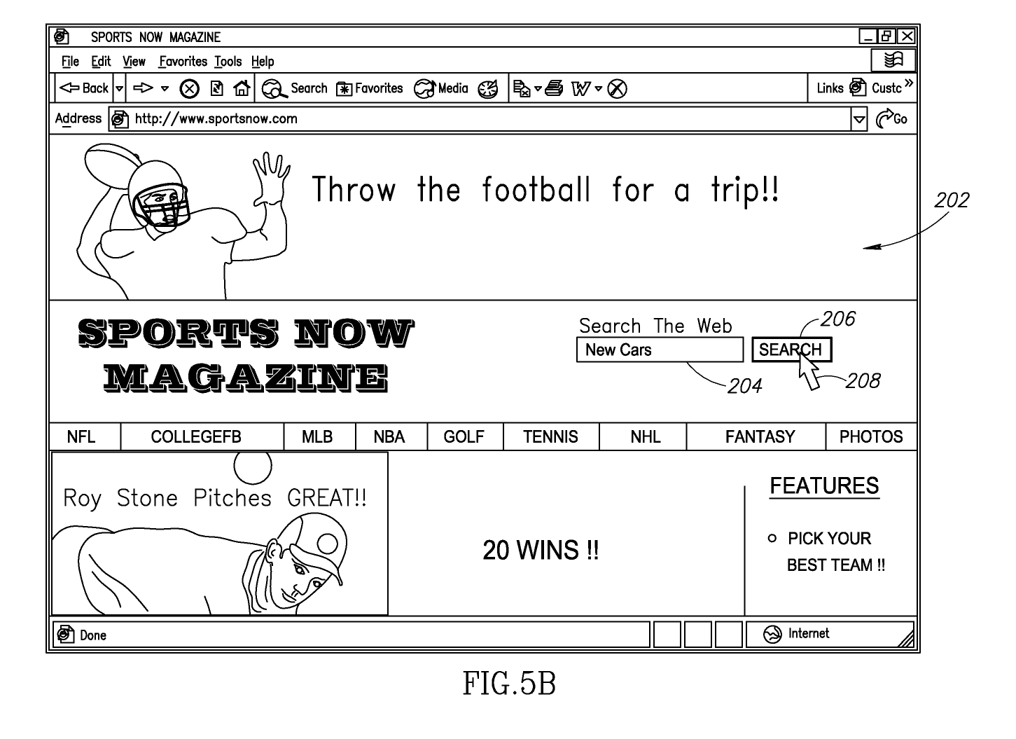

The user 61a, for example, is surfing the web and may be on a web page, such as that for Sports Now Magazine, www.sportsnow.com, shown in FIG. 5A; and hosted by third party server 50a. This web page 202 has a search box 204, from which the web can be searched. Additionally, it has been predetermined that searches from this web site, www.sportsnow.com, are sent to Search Engine 1 (SE1) 52a. The user 61a enters a search query into the search box 204, for example, “New Cars” and clicks on “SEARCH” via the button 206 (the click shown by the arrow 208).

The user's browsing application or browser is now directed to the web site and a landing page or web page 220 of Search Engine 1 (SE1) (www.se1.com), hosted by the server 52a, as shown in FIG. 6A. This web page 220 has listings, including the listing 70 for Bob's Autos, an advertiser affiliated with the system 20 (as this listing has been provided by the listing engine 32, as detailed above). The listing 70 for Bob's Autos is positioned second in the “Sponsored Results” section, as it is the second rank (second ranked bid) for the keyword “NEW CARS”, the keyword that the search engine SE1 (www.se1.com) defined for the search query “New Cars.” The web page 220 draws its data from a database 222, the representation of this database is shown in FIG. 6B.

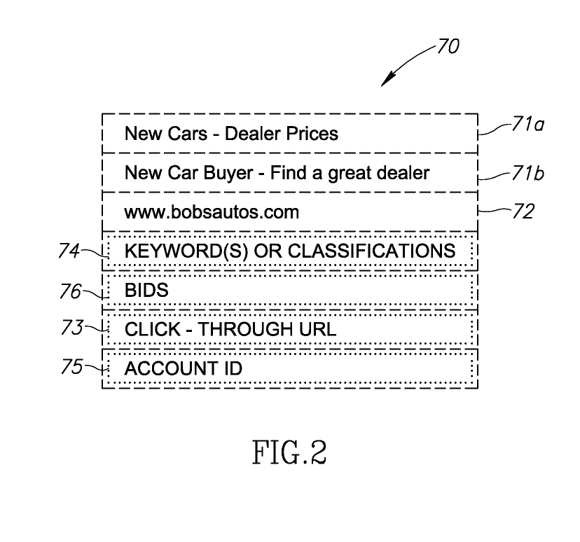

The listing 70 includes links underlying the lines of text. These underlying links include code used by the search engine in redirecting the user's browser to the server(s) associated with the listing. Referring back to FIG. 2, the underlying link for the first line (corresponding to box 71a of FIG. 2) may be, for example:

href=“http://sel.com/?1d=2vyHW16Sr6wkfZxGd0Sk7qvqjGLe77UEdizC69
DNvWcmkcBr8eZlesAmBBI8FrXt7x9/CkOc24tpa/7+XxoH5gBrtgEGcG3Yo6PiH
Jr4A07JaG8ZkVDyw2tO6TCuJmF3kj43+45Wo+xKohvv/IT0Pt1XUrGnND7bMjbL
STnE7BQ1YDhEN3avzAFxdp/dBPBVShHorm2tc3jPhCXRrQjUpeUQboNkOnfElLJ
+k/E/liiXf8XEb6rvUqv3WDmCpARPjhkLtxiRIozsl1rGvyD3htUD3kjgXxy5rX
6ScHokEYOkAWK8DzPgVUslc7NQQ0QxlGqUXayevzzg/CrBfbOlcAF7jwSE9HuWc
6egXgSG3XvwQL”><s pan>New Cars - Dealer Prices </span></a>a
class=“AdBody txt” target=“_blank”

where,
href=“http://se1.com/?1d= . . . vwQL” is the link portion, represented below as “[link portion]”;
se1.com is the IP address for Search Engine 1 (SE1), represented by the server 52a, and,
><span>New Cars-Dealer Prices . . . blank” is specific to the line 71a.
Within the link portion, data sufficient to construct the click through URL for the target web site www.bobsautos.com, is embedded, this click through UKL, for example:
http://bobsautos.homeserver.com/sc/3489765761235987453767645439
such that the once activated, the link facilitates the browser redirect in accordance with the click through URL.

Similarly, the underlying link for the second line (corresponding to box 71b of FIG. 2) includes the same link portion, and may be, for example:

href=“http://se1.com/. . . [link portion] ...vwQL”><span>New Car
Buyer - Find a great dealer</span></a><a class=“AdBody txt”
target=“_blank”

Similarly, the underlying link for the third line (corresponding to box 72 of FIG. 2) includes the same link portion and may be, for example:

href=“http://se1.com/...[link
portion]...vwQL=”><span>www.bobsautos.com<
/span></a><a class=“AdBody txt” target=“_blank”

All of the aforementioned three underlying links are such that they allow the search engine to record information about the click. This information is for example, useful in determining the entity who provided the listing from which the pay per click amount is to be collected from.

For example, the user now clicks on the listing 70 for Bob's Autos, at any of the lines 71a, 71b, 72. The requisite text line that was activated activates the requisite link, that calls up the click through URL, for example: http://bobsautos.homeserver.com/sc/3489765761235987453767645439704456 to redirect the user's browser to the target web site corresponding to the clicked listing. As the click through URL includes “homeserver,” the first redirect of the user's browser is to the home server 30.

The user's browser is now at the home server 30, at block 104. A connection or pipe is now opened between the user's computer 61b and the home server 30.

The account of the advertiser associated with the listing and the bid is now checked to see if there are sufficient funds to cover payment for the click, at block 106. This check may be by querying the Advertiser Accounts database 40b of FIG. 1. If funds are insufficient, the process moves to block 108. Here, an attempt may be made to find another suitable advertiser with sufficient funds or find an arbitrage web page or web site (for example, as contracted with the entity controlling the system 20), for redirection of the browser (the process moves to block 140 where it ends). However, what is typical is that the click is processed as normal, with some exceptions. These exceptions include the advertiser not being billed for the click and the listing is deemed to be inactive, and is noted as such in the database where the listing is stored. A rule is created to stop showing this listing and the rule is communicated to the search engine through the listing engine 32. The process now moves to block 110.

If the account, for example, the funds therein are sufficient, at block 106, or the process comes from block 108, the home server 30 will record and store information about the click (also known as “click information”), in various storage media, at block 110. The user's browser will then be redirected to the conversion server 38, at block 112 (and, for example, the open connection or pipe is transferred to the conversion server 38).

By making this redirect at block 112, the conversion server 38 can determine if there was a conversion at the target web site or web page. The conversion is one of the parameters used when determining the bid to be placed for that particular advertiser in the listings for that advertiser in the search engines, or any rule that will need to be provided or deleted from the requisite search engine for that particular advertiser. The conversion server 38 can send a cookie (cookie file) to the user's browser and connect any subsequent conversion from this user to this click. Optionally, at this time, one or more cookies may be dropped onto the browser of the user's computer 61b, that end up in the computer 61b.

It is then determined if a Time On Site Application can be activated at block 114a. This is determined, for example, by checking for a rule as to the particular search engine being associated with a Time On Site Application. The information as to the search engine, that will activate the requisite browser redirect is determined from the data or code, for example, the identifier for the search engine that redirected the browser to the home server 30 (the search engine ID), that is received by the home server 30 from the search engine when the browser is redirected to the home server 30. If the rule for the particular search engine permits a Time On Site Application, the process moves to block 114b where the conversion server 38 opens a frame and records the opening time. The process moves to block 116. Alternately, if the rule for the particular search engine does not permit a Time On Site Application, the process moves to block 116.

The conversion server 38 then drops one or more cookies onto the browser of the user's computer 61b, at block 116, that end up in the user's computer 61b. A connection or pipe between the conversion server 38 and the browser is reopened. With the connection now open, the conversion server 38 receives the Internet Protocol (IP) address of the user (for example, user1), and the type of browser that the user has, both pieces of information being part of an HTTP request from the user's browser while the user is linked to the network (for example, the Internet 24).

The conversion server 38 the redirects the browser of the user's computer to the target web site, at block 118. Depending on if a frame for the Time On Site (TOS) application has been opened, the redirect may either be in accordance with the Time On Site Application, where the conversion server 38 renders the web pages from the target web site to the frame, or the browser is redirected to the server of the target web site. The target web site is the web site hosted by the target third party server (TTPS, for example, servers 54a-54n) corresponding to the advertiser for which the listing with its bid was clicked on by the user upon accessing the search engine.

For example, in the standard case, the browser associated with the user's computer is redirected to the target web site, through the system 20. Accordingly, the listing 70 for Bob's Autos, when clicked on from the search engine (SE1-www.se1.com) web page, the browser is redirected through the system 20, to the target third party server (TTPS) 54b, that hosts the web page and web site for the corresponding URL www.bobsautos.com. The user 61a (computer 61b and its associated browsing application or browser) will be at the web site for Bob's Autos (www.bobsautos.com), and initially sees the web page known as the landing page, for example, the home page 230, as shown by the screen shot of FIG. 7A.

In the case of the Time On Site Application, the application server 46 activates the Time On Site Application, and keeps the browser of the user's computer therein. The application server then renders the target web site or web page from the target third party server (TTPS) to the application server 44. For example, with the listing 70 for Bob's Autos, www.bobsautos.com, the application server 44 pulls the web site from the target third party server (TTPS) 54b, that hosts www.bobsautos.com. The user 61a will see the screen shot of FIG. 7A, but via the application server 44.

The user, for example, user1 61a is now on the home page 230 for Bob's Autos, hosted by the server 54b with the URL www.bobsautos.com. As shown in FIG. 7B, the user 61a has decided to contact Bob's Autos and accordingly, clicks on the box for “CONTACT US” 232. The click is indicated by the arrow 234.

The browser has now accessed the contact page 232a, as shown in FIG. 7C. The user enters the requisite information in the requisite areas of this page 232a, and clicks on the box for “SEND” 238, the click illustrated by the arrow 240. The web page 232a now changes to a confirmation page 232b, as shown in FIG. 7D. This confirmation page 232b functions as an action page and includes a tracking pixel 242, described above, that is now activated. Activation of the tracking pixel was predetermined to be the conversion event (from which a conversion is determined), that is a parameter used by the conversion server 38. Also, activation of the tracking pixel opens a connection or pipe between the conversion server 38 and the user's computer 61b, through the browser.

After opening this connection, the conversion server 38 queries the browser associated with the computer 61b of the user 61a, to return any cookies (information stored in the cookie file(s)), during any previous electronic communication between the browser and the conversion server 38, such as that described for block 116. The conversion server 38 uses this information, if present, to link the conversion event with the click (from the user, for example, user1 61a).

It is determined if a conversion event has been detected at block 120. If a conversion event has been detected, the process moves to block 122.

The conversion event, in the form of data, as received from the tracking pixel, and detected by the conversion server 38 is collected in the system 20, for example, by the conversion server 38, at block 122. Also, at block 122, cookie(s) are collected from the user's computer 61b, through the browser, through the now-open connection. The tracking pixel data and the cookie(s) are matched to verify that they are from a listing and an associated bid, sent from the system 20, as both the cookie(s) and the tracking pixel are associated with the system 20. If there is a match, for example, the conversion event of the tracking pixel, coupled with the received cookie, are determined to be a conversion. The conversion is translated into data (conversion data), and stored accordingly (in storage associated with the conversion server 38, data server 40 or the like), for use by the analytics engine 46 (as detailed below).

The process moves to block 124a, where it is determined if Time On Site Information is available. This is where the Time On Site Application was activated at block 114b. If the Time On Site Application was activated, the process moves to block 124b, where the time of the frame closure is recorded and stored. The process moves to block 126. If the Time On Site Application was not activated, the process moves to block 126.

With the conversion and/or Time On Site (TOS) data collected, analytics will be run by the analytics engine 46, where the bid to the requisite search engine will be recalculated, the creation or deletion of a rule for the search engine, and/or other action, will be determined, for the particular advertiser, at block 126. These analytics are described in detail below.

This determination is communicated to the search engine at block 126, through either the listing engine 32 and/or the bid engine 34, such that the one or more parameters of the search engine are modified, for the next interval, beginning at a time T₂ (subsequent to time T₁). Alternately, all parameters may be kept the same and unchanged, if this is the result of the analysis of block 126. The process ends at block 140.

Turning back to block 120, if a conversion event has not been detected, the process moves to block 130, where it is determined if Time On Site Information is available. This is where the Time On Site Application was activated at block 114b. If the Time On Site Application was activated, the process moves to block 134, where the time of the frame closure is recorded and stored. The process then moves to block 126 and continues to block 140 from there. If the Time On Site Application was not activated, the process moves to block 138.

At block 138, it is determined if a tracking pixel was downloaded by the target web site. If yes, the process moves to block 126 and continues to block 140 from there. If, no, the process moves to block 140, where it ends.

### Analytics

The analytics of block 126 are now detailed further, in accordance with the following Scenarios. These Scenarios are exemplary only, and are not limiting to the numerous methods in which analytics may be performed, depending on the system, the clicks, and the like.

In determining the subsequent (adjusted or revised) bid, the click data is analyzed against a metric to determine a Q value. This Q value is used to initially adjust the present pay per click amount (PPPC) that the advertiser (web site promoter or the like) will pay to the party controlling the system 20. The adjusted pay per click (APPC) value will then be modified, for example, divided, by the profit margin factor (PMF), and optionally altered by other factors to determine the bid that will be placed in the search engine for the particular keyword, for the advertiser.

The Q value is a ratio of the advertiser?s cost per conversion, expressed as SCPA in the above-described process, versus the cost per conversion of another parameter or metric of a known quality, for example, e-mail conversions, for example, from the Bid System, expressed as ECPA. The objective may be, for example, to get the advertiser?s cost per conversion (SCPA) of the process described above equal to the cost per conversion of email, such that the value for Q is at least as close to 1 as possible. A Q value of 1 means that the traffic from the search engines is at the same quality as the traffic sources it is being compared against, such as e-mail from the perspective of the advertiser. For example, if 2 of 3 (66%) of clicks are fraudulent, and will never result in a valid conversion for the requisite listing (of the advertiser or target web site), the system 20 will pay the ⅓ of the PPC amount of a known high quality (for example, e-mail) to a traffic source (e.g., a search engine), as the effects of receiving fraudulent traffic are minimized, if not eliminated.

The e-mail parameter or metric is easily determined when the advertiser using the process detailed above is also a bid system advertiser, who has an e-mail metric as to cost per conversions. In the Bid System, as described in U.S. patent application Ser. No. 11/256,871, a conversion may he defined as described above (based on one or more conversion events either alone or coupled with other events, occurrences, or the like), and tracking pixels may be placed in the requisite web pages, along with cookies, as defined above. Also, in the Bid System, the users (e-mail recipients), who may, and usually are different from the users of the aforementioned search engines from which the ECPA values are determined, have computers whose browsing applications are directed to the target web site. From these target web sites, the conversions for these ECPA values are obtained, by opening an e-mail and clicking on the listings of the resultant on-screen creative (and activating the underlying links).

Throughout the aforementioned scenarios, the following equations will be used. First, the cost of a conversion (SCPA) for the advertiser for the requisite search engine or search engines is determined by Equation 1 (Eq. 1):

SCPA=TADV/CONV (Eq. 1)

where,
TADV is total amount spent by the advertiser for the portion of the clicks that could have resulted in a conversion being communicated to the system 20 through the conversion server 38; and,
CONV is the total number of search conversions, for example, a search conversion being a tracking pixel data-cookie match as detailed above, communicated to the conversion server 38 for those clicks.

Next, the Q value is determined by Equation 2 (Eq. 2):

Q=ECPA/SCPA (Eq. 2)

The Advertiser Adjusted Pay Per Click (APPC) is then determined by Equation 3 (Eq. 3):

APPC=Q·PPPC (Eq. 3)

The subsequent, revised or adjusted bid (RBID) will is determined by Equation 4 (Eq. 4):

RBID=APPC·(1/PMF) (Eq. 4)

In the case where the Time On Site Application is run, it can be used to estimate the number of search conversions from the system (SCPA), when other search conversion data, such as that from the tracking pixel data-cookie match is unavailable. For example, a conversion could be scored as 0.05 for a time on site of between 2 and 3600 seconds. The total number of these conversions is then summed to determine the value for CONV. The Time On Site range may be adjusted by the account manager, system administrator or the like.

The advertiser adjusted PPC (APPC) and the revised bid (RBID) are independent of each other and may be calculated by other factors. The following scenarios are non-limiting examples of how PPC values and bids may be adjusted, rules provided, and other actions taken. The bids are adjusted, rules provided and other actions taken at time intervals, that may, for example, range from fifteen minutes to months. For discussion purposes, a first interval starts at time T₁ and a subsequent interval begins at time T₂, the end of the interval that started at time T₁.

### Scenario 1

Using the diagram of FIG. 3 for the listing www.bobsautos.com (associated with the advertiser or web site promoter for Bob's Autos), in the predetermined interval (that began at time T₁ and ended at time T₂), there were two search conversions, and e-mail ran at $40 per conversion. There were 100 search clicks for which the advertiser paid the entity controlling the system $1 per click, for a total cost of $100.

According to Equation 1 (Eq. 1), the advertiser's cost per conversion (SCPA) is calculated as:

SCPA=$100/2 search conversions=$50/search conversion
From Equation 2, Q=ECPA/SCPA=$40/$50=0.8
From Equation 3, the advertisers PPC will be revised, such that:

APPC=Q·PAPPC=0.8·$1=$0.80

Next, assuming a profit margin of 100% that correlates to a profit margin factor (PMF) of 2, and applying Equation 4 (Eq. 4):

RBID=APPC/PMF=$0.80/2=$0.40

Accordingly, for Bob's Autos listings in Search Engine 1 for this second interval, the Bid Engine 34 will submit a revised bid (RBID) for the listing as $0.40 for the next or new time interval (beginning at time T₂). This revised bid is updated for the requisite search engine, for example, Search Engine 1 (SE1), with the update shown in the diagram of FIG. 8.

### Scenario 1A

This Scenario is the same as Scenario 1, except that conversion data for the system 20 is determined by a Time On Site (TOS) application. It will be assumed that a “good” Time On Site (TOS) is between 2 and 3600 seconds. Conversion data (search conversion data) will be taken from these “good” times on site. Accordingly, for example, there were four instances of time on site of 3000, 2000, 2000 and 3000 seconds. Additionally, from observation of past clicks, it has been determined that approximately 5% of these click with “good” Time On Site actually convert, hence, the factor of 0.05 for every “good” Time On Site.

Summing these values gives a CONV as follows:

CONV=0.05·4=0.2
Using the same parameters as in Scenario 1 and according to Equation 1, the advertiser's cost per conversion (SCPA) is calculated as:

SCPA=$100/0.2 conversion=$500/conversion
From Equation 2, Q=ECPA/SCPA=$40/$500=0.08
From Equation 3, the advertiser's PPC will be revised, such that:

APPC=Q·PAPPC=0.08·$1=$0.08
Assuming a profit margin of 100% that correlates to a profit margin factor (PMF) of 2, from Equation 4:

RBID=APPC/PMF=$0.08/2=$0.04

Accordingly, for Bob's Autos listings in Search Engine 1 for this second interval, the Bid Engine 34 will revise the bid for the listing as $0.04 for this new interval (beginning at time T₂).

### Scenario 1B

This scenario uses the advertiser for Bob's Autos (the advertiser) in Search Engine 1, with its accompanying data from FIG. 3. Here, the advertiser pays the system 20 $1 for each click. The ECPA is from e-mail in the Bid System, as per Scenario 1.

For the time interval beginning at time T₁, Search Engine 1, received 100 clicks with 0 conversions.

There were 100 total clicks, costing the System 20 $50, and costing the advertiser, Bob's Autos, a total expense of $100.

As a result of receiving 0 clicks and to avoid an infinite value for SCPA, a hypothetical 1 conversion will be used. According to Equation 1, the advertiser's cost per conversion (SCPA) is calculated as.

SCPA=$100/1 conversion=$100/conversion
From Equation 2, Q=ECPA/SCPA=$40/$100=0.4
From Equation 3, the advertiser's PPC for Search Engine 1 will be revised, such that:

APPC=Q·PAPPC=0.4*$1=$0.40
Assuming a profit margin of 100% that correlates to a profit margin factor (PMF) of 2, and applying Equation 4:

RBID=APPC/PMF=$0.40/2=$0.20

Accordingly, for Bob's Autos listings in Search Engine 1 for this second interval, the Bid Engine 34 will send a revised bid (RBTD) for the listing as $0.20 for the next or new time interval (beginning at time T₂).

The system 20, in particular the analytics engine 46 now creates a policy that if this traffic pattern continues for a certain number of time intervals, after a certain number of time intervals, a rule will be created and sent to the requisite search engine to shut off traffic for the listing of the advertiser (i.e., Bob's Autos), on that search engine. The shut off can be for a predetermined time, or amount of time intervals, or permanent.

Alternately, if the 100 clicks for which the advertiser paid $100 without any conversions came from a search originating in the www.movies.com, a rule may be communicated to Search Engine 1 not to send the system 20 any clicks or traffic for the keyword, classification or category “NEW CARS” when it receives the click from www.movies.com, for example, as represented by the third party server 50c in FIG. 1. This new rule is shown in FIG. 8, for the second interval, beginning at time T₂.

### Scenario 2

Returning to FIG. 3, a listing for Al's Autos is showing on the web page for Search Engine 1 in the Sponsored Results Section. Al's Autos is not a Bid System advertiser, and accordingly, lacks an e-mail parameter or metric. It has a tracking pixel, so a number of conversions can be obtained for the interval.

There were three conversions. There were 100 clicks for which the advertiser paid the entity controlling the system $0.90 per click, for a total cost of $90. A value for ECPA must be selected, so the ECPA for Bob's Autos will be used, as this is a comparable to Al's Autos, as both are in the same classification.

According to Equation 1, the advertiser's cost per conversion (SCPA) is calculated as.

SCPA=$90/3 conversions=$30/conversion
From Equation 2, Q=ECPA/SCPA=$40/$30=1.33
From Equation 3, the advertiser's PPC will be revised, such that:

APPC=Q·PAPPC=1.33·$0.90=$1.20
Assuming a profit margin of 100% that correlates to a profit margin factor (PMF) of 2, and applying Equation 4:

RBID=APPC/PMF=$1.20/2=$0.60

Accordingly, for Al's Autos listings in Search Engine 1 (SE1) for this second, next or subsequent time interval (Beginning at time T₂), the Bid Engine 34 will include the revised bid (RBID) for the listing as $0.60 for this next time interval.

### Scenario 3

Returning to FIG. 3, a listing for Cal's Cars is showing on the web page for Search Engine 1, and, for example, is placed in the Sponsored Results Section of the search engine's (SE1's) web page, similar to that shown in FIG. 6. Cal's Cars is not a bid system advertiser and does not have a tracking pixel. Accordingly, the number of conversions is not obtainable.

However, looking at a comparable target web site, for example, Bob's Autos, www.bobsautos.com, e-mail is running at $40/conversion or ECPA=$40/conversion, as taken from Scenario 1. Next, to obtain a SCPA value, the SCPA from Scenario 1B can be used, as it is broader than a single listing, and is typically more representative of the listings for the category in the search engine. Accordingly, the SCPA=$60/conversion.

As the SCPA has been determined, Equation 1 is not necessary and Equation 2 can be applied.
From Equation 2, Q=ECPA/SCPA=$40/$60=0.66
From Equation 3, the advertiser's PPC will be revised, such that:

APPC=Q=PAPPC=0.66·$0.70=$0.47
Assuming a profit margin of 100% that correlates to a profit margin factor (PMF) of 2, and applying Equation 4:

RBID=APPC/PMF=$0.47/2=$0.24

Accordingly, for Cal's Cars listings in Search Engine 1 for this second time interval (beginning at time T₂), the Bid Engine 34 will have a new or revised bid for the listing of $0.24 (RBID) for this next or new interval, and the system 20 should charge as much as $0.47 for each click to the advertiser Cal's Cars (or the web site promoter associated therewith).

### Scenario 4

Search Engine 1 (SE1), represented by FIG. 3 in the system 20, receives clicks or traffic from two separate web sites, Sports Now Magazine (www.sportsnow.com), as represented by the server 50a, and movies.com (www.movies.com), represented by the server 50c. Assuming the movies.com server is run by a party who has decided to artificially increase clicks by clicking on listings that appear at the web site movies.com, that will result in the click being directed to the requisite search engine, for example, Search Engine 1 (SE1). This is done so much, that only 1 in 25 clicks from movies.com is a valid click, and as such, has any chance of resulting in a conversion.

The system 20 receives 100 clicks from Search Engine 1 (SE1) during the time interval from time 1 (T₁) to time 2 (T₂). Of the 100 clicks, 50 are from Sports Now Magazine (www.sportsnow.com), server 50a, and 50 are from movies.com, server 50c. Due to fraudulent clicks from movies.com, only 2 of these 50 clicks are valid and have any chance of conversion, while all 50 clicks from Sports Now Magazine (www.sportsnow.com) are valid and all may be potentially converted.

When comparing the SCPA values for Search Engine 1 (SE1) only 52 clicks of the 100 clicks received are valid, and have any potential for resulting in a conversion.

Accordingly, for the Advertiser, Bob's Autos (www.bobsautos.com) on Search Engine 1 (SE1), the 100 clicks paid the system $100 (100 clicks at $1/click), and there were two total conversions. The ECPA for e-mail was $25.

According to Equation 1, the advertiser's cost per conversion (SCPA) is calculated as:

SCPA=$100/2 conversions=$50/conversion
From Equation 2, Q=ECPA/SCPA=$25/$50=0.5
From Equation 3, the advertiser's PPC will be revised, such that:

APPC=Q·PAPPC=0.5·$1.00=$0.50
Assuming a profit margin of 100% that correlates to a profit margin factor (PMF) of 2, and applying Equation 4:

RBID=APPC/PMF=$0.50/2=$0.25

If the system 20 simply lowered the bids on Search Engine 1 (SE 1) for Bob's Autos, then the system 20 will get fewer clicks from Sports Now Magazine (www.sportsnow.com), server 50a, as Search Engine 1 (SE1) will prefer to sell clicks at $0.50, rather than at $0.25. As a result, the ratio of lower value clicks increases as movies.com, server 50c, continues to sell lower value clicks at $0.25, whereas Sports Now Magazine (www.sportsnow.com) will reduce the supply of higher value clicks due to the lowered price, from www.movies.com.

However, the system 20 segments traffic of Search Engine 1 (SE1) into the various web sites, for example, third party servers 50a-50n, and runs calculations for each segment (web site sending clicks or traffic).

In one segment, for the advertiser Bob's Autos (www.bobsautos.com) on Sports Now Magazine (www.sportsnow.com), 50 clicks were received at $1 each, with 2 conversions. The ECPA is $25.

According to Equation 1, the advertiser's cost per conversion (SCPA) is calculated as:

SCPA=$50/2 conversions=$25/conversion
From Equation 2, Q=ECPA/SCPA=$25/$25=1
From Equation 3, the advertiser's PPC will be revised, such that:

APPC=Q·PAPPC=1·$1=$1.00
Assuming a profit margin of 100% that correlates to a profit margin factor (PMF) of 2, and applying Equation 4:

RBID=APPC/PMF=$1.00/2=$0.50

Accordingly, bids from the system 20 to the search engine (Search Engine 1 (SE1)) are kept at $0.50. The bid engine 34 can either send this $0.50 bid for the listing for Bob's Autos for this next time interval or not send anything until there is a change in the bid for the requisite subsequent time interval.

In the other segment, for the advertiser Bob's Autos (www.bobsautos.com) on Search Engine 1 (SE1) from movies.com (www.movies.com), 50 clicks were received at $1 each, with 0 conversions. The ECPA is $25.

According to Equation 1, the advertiser's cost per conversion (SCPA) is calculated as:

SCPA=$50/0 conversions=infinite
However, to avoid the infinite result, a “1” is substituted for “0” conversions, as described for Scenario 1B above.

According to Equation 1, the advertisers cost per conversion (SCPA) is calculated as:

SCPA=$50/1 conversions=$50/conversion
From Equation 2, Q=ECPA/SCPA=$25/$50=0.5
From Equation 3, the advertiser's PPC will be revised, such that:

APPC=Q·PAPPC=0.5·$1=$0.50
Assuming a profit margin of 100% that correlates to a profit margin factor (PMF) of 2, and applying Equation 4.

RBID=APPC/PMF=$0.50/2=$0.25
A revised bids (RBID) of $0.25 is now sent to the bid engine 34 for the listing for the advertiser Boh's Autos. After sufficient clicks have been received, for example, approximately 500, this source of clicks or traffic is blocked, and a rule to this effect is sent to the search engine, for example, Search. Engine 1 (SE1) 52a (for example, from the bid engine 34a) to block traffic from movies.com, server 50c, for a predetermined time.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for traffic management over a network comprising:
placing a bid corresponding to a listing associated with a target web site the bid defining a present bid;
directing the browsing application of a computer device associated with at least one entity who has activated the listing associated with the target web site to the target web site;
receiving data associated with the browsing application associated with the at least one entity having accessed the target web site;
analyzing the received data with respect to at least one parameter associated with the target web site to determine a subsequent bid; and,
providing the subsequent bid to the listing associated with the target web site.

2. The method of claim 1, additionally comprising providing the subsequent bid to the listing associated with the target web site, if the subsequent bid is of a different amount than the amount of the present bid.

3. The method of claim 1, wherein providing the bid corresponding to the listing includes placing the bid with a search engine.

4. The method of claim 3, wherein receiving data associated with the browsing application includes receiving indications of conversions over a predetermined time interval.

5. The method of claim 4, additionally comprising: calculating a cost per conversion (SCPA) based on the amount a web site promoter spent for redirections of browsing applications to the target web site during the predetermined time interval and the number of conversions received from the target web site during the predetermined time interval.

6. The method of claim 5, additionally comprising: providing at least one cookie to the browsing application when the browsing application is in electronic communication with the target web site upon the browsing application being directed to the target web site.

7. The method of claim 6, wherein a conversion includes a match between each indication of a conversion event from the target web site and a corresponding at least one cookie.

8. The method of claim 5, wherein the at least one parameter includes the cost per conversion (ECPA) for a predetermined time interval based on browser redirections to the target web site associated with electronic mail.

9. The method of claim 7, wherein the indication of the conversion event from the target web site includes receiving at least one indication of the activation of a tracking pixel from an action web page of the target web site.

10. The method of claim 5, wherein a conversion is based on data corresponding to the time the browsing application is open at the target web site

11. The method of claim 8, wherein the subsequent bid (RBID) to be placed in the search engine is in accordance with the equation:
RBID=ECPA/SCPA·PPPC·PMF
where,
PPPC is the pay per click amount a web site promoter is paying for each redirection of a browsing application to the target web site; and,
PMF is a profit margin factor.

12. A system for traffic management over a network comprising:
a first component for providing a bid corresponding to a listing associated with a target web site, the bid defining a present bid;
a second component for directing the browsing application of a computer device associated with at least one entity who has activated the listing associated with the target web site to the target web site;
a third component for receiving data associated with the browsing application associated with the at least one entity having accessed the target web site;
a fourth component for analyzing the received data with respect to at least one parameter associated with the target web site to determine a subsequent bid; and,
a fifth component for providing the subsequent bid to the listing associated with the target web site.

13. The system of claim 12, wherein the fifth component is additionally configured for providing the subsequent bid to the listing associated with the target web site, if the subsequent bid is of a different amount than the amount of the present bid.

14. The system of claim 12, wherein the first component is additionally configured for placing the provided bid corresponding to the listing with a search engine.

15. The system of claim 14, wherein the third component for receiving data associated with the browsing application is configured for receiving indications of conversions over a predetermined time interval.

16. The system of claim 15, additionally comprising: a sixth component for calculating a cost per conversion (SCPA) based on the amount a web site promoter spent for redirections of browsing applications to the target web site during the predetermined time interval and the number of conversions received from the target web site during the predetermined time interval.

17. The system of claim 16, wherein the third component is additionally configured for providing at least one cookie to the browsing application when the browsing application is in electronic communication with the target web site upon the browsing application being directed to the target web site.

18. The system of claim 17, wherein the third component is additionally configured for defining a match between each indication of a conversion event from the target web site and a corresponding at least one cookie.

19. The system of claim 16, wherein the fourth component is configured such that the at least one parameter includes the cost per conversion (ECPA) for a predetermined time interval based on browser redirections to the target web site associated with electronic mail.

20. The system of claim 18, wherein the third component is configured for receiving the indication of the conversion event from the target web site by receiving at least one indication of the activation of a tracking pixel from an action web page of the target web site.

21. The method of claim 16, additionally comprising a seventh component for obtaining conversion data based on the time the browsing application is open at the target web site

22. The method of claim 19, wherein the fourth component is configured to calculate a subsequent bid (RBID) in accordance with the equation:
RBID=ECPA/SCPA·PPPC·PMF
where,
PPPC is the pay per click amount a web site promoter is paying for each redirection of a browsing application to the target web site; and,
PMF is a profit margin factor.

23. A computer-usable storage medium having a computer program embodied thereon for causing a suitably programmed system to manage traffic over a network, by performing the following steps when such program is executed on the system:
placing a bid corresponding to a listing associated with a target web site, the bid defining a present bid;
directing the browsing application of a computer device associated with at least one entity who has activated the listing associated with the target web site to the target web site;
receiving data associated with the browsing application associated with the at least one entity having accessed the target web site;
analyzing the received data with respect to at least one parameter associated with the target web site to determine a subsequent bid; and,
providing the subsequent bid to the listing associated with the target web site.

24. The computer usable storage media of claim 23, wherein providing the subsequent bid to the listing associated with the target web site, includes providing the subsequent bid if the subsequent bid is of a different amount than the amount of the present bid.

25. The computer usable storage media of claim 23, wherein providing the bid corresponding to the listing includes placing the bid with a search engine.

26. The computer usable storage media of claim 25, wherein receiving data associated with the browsing application includes receiving indications of conversions over a predetermined time interval.

27. The computer usable storage media of claim 26, wherein the steps additionally comprise: calculating a cost per conversion (SCPA) based on the amount a web site promoter spent for redirections of browsing applications to the target web site during the predetermined time interval and the number of conversions received from the target web site during the predetermined time interval.

28. The computer usable storage media of claim 27, wherein the steps additionally comprise, causing at least one cookie to be provided to the browsing application when the browsing application is in electronic communication with the target web site upon the browsing application being directed to the target web site.

29. The computer usable storage media of claim 28, wherein a conversion includes a match between each indication of a conversion event from the target web site and a corresponding at least one cookie.

30. The computer usable storage media of claim 27, wherein the at least one parameter includes the cost per conversion (ECPA) for a predetermined time interval based on browser redirections to the target web site associated with electronic mail.

31. The computer usable storage media of claim 29, wherein the indication of the conversion event from the target web site includes receiving at least one indication of the activation of a tracking pixel from an action web page of the target web site.

32. The computer usable storage media of claim 27, wherein a conversion is based on data corresponding to the time the browsing application is open at the target web site

33. The computer usable storage media of claim 23, wherein the subsequent bid (RBID) to be placed in the search engine is in accordance with the equation:
RBID=ECPA/SCPA·PPPC·PMF
where,
PPPC is the pay per click amount a web site promoter is paying for each redirection of a browsing application to the target web site; and,
PMF is a profit margin factor.

34. A method for traffic management over a network comprising:
providing a bid corresponding to a listing associated with a target web site;
directing the browsing application of a computer device associated with at least one entity who has activated the listing associated with the target web site to the target web site;
receiving data associated with the browsing application associated with the at least one entity having accessed the target web site;
analyzing the received data with respect to at least one parameter associated with the target web site to determine an at least one rule for the listing with the bid; and
electronically communicating the at least one rule to the at least one listing.

35. The method of claim 34, additionally comprising analyzing the received data with respect to that at least one parameter to determine an action for the at least one rule.

36. The method of claim 35, wherein the action for the at least one rule includes at least one of removing the at least one rule from being in force, maintaining the at least one rule in force, or adding at least one new rule.

37. The method of claim 34, wherein providing the at least one rule includes providing the at least one rule to a search engine.

38. The method of claim 36, wherein receiving data associated with the browsing application includes receiving indications of conversions over a predetermined time interval.

39. The method of claim 38, additionally comprising: calculating a cost per conversion (SCPA) based on the amount a web site promoter spent for redirections of browsing applications to the target web site during the predetermined time interval and the number of conversions received from the target web site during the predetermined time interval.

40. The method of claim 39, additionally comprising: providing at least one cookie to the browsing application when the browsing application is in electronic communication with the target web site upon the browsing application being directed to the target web site.

41. The method of claim 40, wherein a conversion includes a match between each indication of a conversion event from the target web site and a corresponding at least one cookie.

42. The method of claim 41, wherein the at least one parameter includes the cost per conversion (ECPA) for a predetermined time interval based on browser redirections to the target web site associated with electronic mail.

43. The method of claim 41, wherein the indication of the conversion event from the target web site includes receiving at least one indication of the activation of a tracking pixel from an action web page of the target web site.

44. The method of claim 39, wherein a conversion is based on data corresponding to the time the browsing application is open at the target web site

45. The method of claim 41, wherein the action for the at least one rule is in accordance with the equation:
Q=ECPA/SCPA
where,
Q is a ratio of the quality of the traffic.
